(19) United States
(12) Patent Application Publication
(10) Pub. No.: US 2025/0187968 A1
(43) Pub. Date: Jun. 12, 2025

(54) METHOD FOR PRODUCING GLASS ARTICLE

(71) Applicant: NIPPON ELECTRIC GLASS CO., LTD., Shiga (JP)

(72) Inventors: Rikuro AI, Shiga (JP); Mutsumu FUKADA, Shiga (JP)

(21) Appl. No.: 18/843,780

(22) PCT Filed: Mar. 14, 2023
(86) PCT No.: PCT/JP2023/009911

§ 371 Date: Sep. 4, 2024

(30) Foreign Application Priority Data
Mar. 28, 2022 (JP) 2022-051634

(51) Int. Cl. C03B 17/06

(52) U.S. Cl. CPC C03B 17/064

(57) ABSTRACT

A method of manufacturing a glass article includes a forming step of causing a first molten glass (Gm1) including TiO₂ to flow down along a surface of a forming trough (15) including an yttrium-containing oxide by a down-draw method to form a glass ribbon (G). The forming trough (15) includes a Mg-rich layer (MR) including magnesium on the surface thereof.

### TECHNICAL FIELD

The present invention relates to a method of manufacturing a glass article.

### BACKGROUND ART

In a manufacturing process for a glass article, such as a glass sheet or a glass roll, for example, molten glass is caused to flow down along the surface of a forming trough by a down-draw method to continuously form a glass ribbon. The glass ribbon having been formed is cooled to near room temperature while being conveyed to a downstream side, and is then cut every predetermined length so as to provide a glass sheet, or taken up into a roll shape so as to provide a glass roll (see, for example, Patent Literature 1).

### CITATION LIST

Patent Literature 1: JP 2018-062433 A

### SUMMARY OF INVENTION

### Technical Problem

in the above-mentioned forming trough, from the viewpoint of increasing the mechanical strength thereof, an yttrium-containing oxide (e.g., Y₃Al₅O₁₂, which is a composite oxide of yttrium and aluminum) is added to constituent components of the forming trough in some cases.

The inventors of the present invention have repeated extensive investigations, and as a result, have found for the first time the following problem: when a glass ribbon comprising TiO₂ is formed by using such forming trough comprising an yttrium-containing oxide, yttrium oxide (Y₂O₃) is, for example, eluted from the yttrium-containing oxide serving as an additive to the forming trough to diffuse into molten glass, to thereby generate a devitrified product. Such devitrified product derived from the yttrium-containing oxide may cause a defect in the glass ribbon and/or a glass article, and hence it is important to reduce the generation amount thereof also from the viewpoints of improving production efficiency and quality. The devitrified product derived from the yttrium-containing oxide is conceivably generated through a reaction between yttrium oxide having diffused into the molten glass and TiO₂ in the molten glass. That is, it is conceived that the devitrified product derived from the yttrium-containing oxide is a devitrified product (Y₂O₃—Ti₂O crystal) comprising yttrium oxide and TiO₂.

An object of the present invention is to reliably reduce the generation of a devitrified product derived from an yttrium-containing oxide included in a forming trough when a glass ribbon is formed by a down-draw method.

### Solution to Problem

(1) According to one embodiment of the present invention, which has been devised in order to achieve the above-mentioned object, there is provided a method of manufacturing a glass article, comprising a forming step of causing a first molten glass comprising TiO₂ to flow down along a surface of a forming trough comprising an yttrium-containing oxide by a down-draw method to form a glass ribbon, wherein the forming trough comprises a Mg-rich layer comprising magnesium on the surface of the forming trough.

With this configuration, the Mg-rich layer is formed on the surface of the forming trough. The Mg-rich layer functions as a diffusion suppression layer for suppressing diffusion of the yttrium-containing oxide. For that reason, the diffusion of the yttrium-containing oxide included in the forming trough into the first molten glass can be reliably suppressed. Accordingly, a reaction between the yttrium-containing oxide included in the forming trough and TiO₂ included in the first molten glass is less liable to occur, with the result that the generation of a devitrified product derived from the yttrium-containing oxide can be reliably reduced.

(2) In the configuration of Item (1), it is preferred that the forming trough be an alumina-based forming trough, and the Mg-rich layer comprise spinel as a main component.

With this configuration, the alumina-based forming trough comprises alumina, and hence the Mg-rich layer comprising spinel (MgAl₂O₄) as a main component is easily formed on the surface of the forming trough.

(3) In the configuration of Item (1) or (2), it is preferred that the first molten glass comprise MgO.

With this configuration, the Mg-rich layer is easily formed on the surface of the forming trough and maintained thereon.

(4) In the configuration of any one of Items (1) to (3), it is preferred that the method further comprise, as a preliminary step to the forming step, a formation step of causing a second molten glass comprising MgO to flow down along the surface of the forming trough to form the Mg-rich layer on the surface of the forming trough.

With this configuration, the Mg-rich layer can be sufficiently formed on the surface of the forming trough in advance before the forming step.

(5) In the configuration of any one of Items (1) to (4), it is preferred that the first molten glass comprise as a glass composition, in terms of mass %, 50% to 80% of SiO₂, 3% to 25% of Al₂O₃, 0% to 20% of B₂O₃, 0% to 25% of Li₂O₃+Na₂O+K₂O, 0% to 20% of MgO, 0% to 20% of CaO, 0% to 20% of SrO, 0% to 20% of BaO, 0% to 1% of As₂O₃, 0.0001% to 2% of SnO₂, and 0.001% to 10% of TiO₂, and have a mass ratio SnO₂/(As₂O₃+SnO₂) of from 0.001 to 1.

With this configuration, although the devitrified product may be generated owing to incorporation of TiO₂, the application of the present invention can reliably suppress the foregoing and provide a high-quality glass article. Moreover, the glass article having the above-mentioned glass composition can reduce the transmittance of ultraviolet light while preventing coloring caused by ultraviolet light, and can be suitably utilized as, for example, a cover glass of a solar cell (glass substrate for space solar power generation) to be used in outer space.

### Advantageous Effects of Invention

According to the present invention, the generation of a devitrified product derived from an yttrium-containing oxide included in a forming trough when a glass ribbon is formed by a down-draw method can be reliably reduced.

### BRIEF DESCRIPTION OF DRAWINGS

FIG. 1 is a vertical sectional view of a manufacturing apparatus for a glass article according to an embodiment of the present invention.

FIG. 2 is a vertical sectional view for illustrating the vicinity of a forming trough of the manufacturing apparatus for a glass article according to the embodiment of the present invention in an enlarged manner.

FIG. 3 is a vertical sectional view for illustrating a step of forming a Mg-rich layer on the surface of the forming trough of FIG. 2.

### DESCRIPTION OF EMBODIMENTS

Now, an embodiment of the present invention is described with reference to the attached drawings. In the figures, the X direction represents a horizontal direction, and the Z direction represents a perpendicular direction.

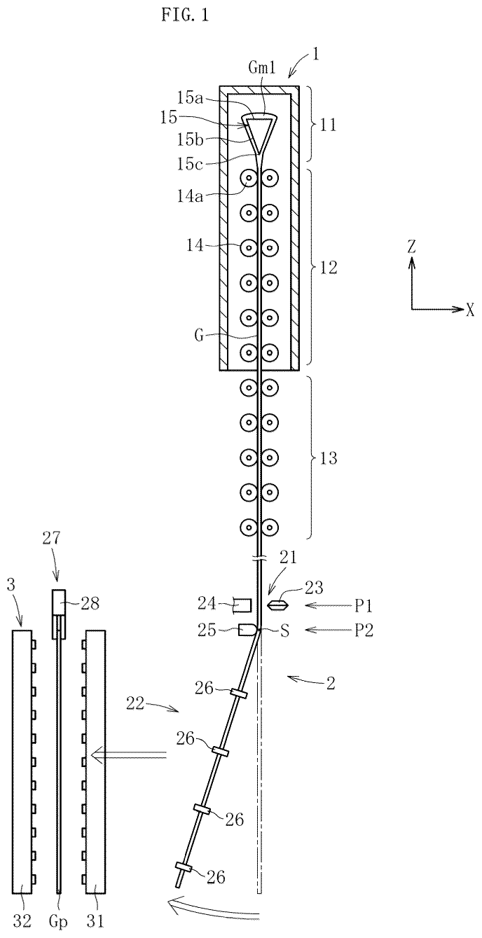

As illustrated in FIG. 1, a manufacturing apparatus for a glass article according to this embodiment is an apparatus for manufacturing a glass sheet Gp serving as a glass article. This manufacturing apparatus comprises: a treatment device 1 for a glass ribbon G; a cutting device 2; and an inspection device 3.

The treatment device 1 comprises a forming zone 11 for continuously forming the glass ribbon G, a heat treatment zone 12 for subjecting the glass ribbon G to heat treatment (annealing), a cooling zone 13 for cooling the glass ribbon G to near room temperature, and roller pairs 14 arranged in each of the forming zone 11, the heat treatment zone 12, and the cooling zone 13 in a plurality of stages in an up-and-down direction.

The forming zone 11 and the heat treatment zone 12 are each formed of a furnace in which the periphery of a conveying path of the glass ribbon G is surrounded by a wall portion, and each have a heating device for controlling the temperature of the glass ribbon G, such as a heater, arranged at an appropriate position of the furnace. Meanwhile, the cooling zone 13 is open to an ambient atmosphere at normal temperature without having the periphery of the conveying path of the glass ribbon G surrounded by a wall portion, and does not have a heating device such as a heater arranged therein. The glass ribbon G is subjected to a desired thermal history by passing through the heat treatment zone 12 and the cooling zone 13.

A forming trough 15 for forming the glass ribbon G from a first molten glass Gm1 by an overflow down-draw method is arranged in an internal space of the forming zone 11. Herein, the “first molten glass Gm1” means molten glass for forming the glass ribbon G serving as a product. The first molten glass Gm1 supplied to the forming trough 15 is overflowed from a groove portion (not shown) formed in a top 15a of the forming trough 15. The overflowed first molten glass Gm1 flows along both side surfaces 15b having a wedge-shaped cross-section of the forming trough 15 to be joined together (fusion integration) at a lower end 15c, to thereby continuously form the glass ribbon G having a sheet shape. The formed glass ribbon G is in a vertical posture (preferably a perpendicular posture). The glass ribbon G and the glass sheet Gp each have substantially the same glass composition as the first molten glass Gm1. Along with the joining (fusion integration), a joined surface is formed in an inside (e.g., a center portion in a thickness direction) of each of the glass ribbon G and the glass sheet Gp.

The forming trough 15 comprises an yttrium-containing oxide (e.g., Y₃Al₅O₁₂, which is a composite oxide of yttrium and aluminum) in order to ensure its mechanical strength. In this embodiment, the forming trough 15 is an alumina-based forming trough comprising an yttrium-containing oxide. The alumina-based forming trough comprising an yttrium-containing oxide preferably has a content of alumina of from 90 mass % to 96 mass and a content of the yttrium-containing oxide of from 2 mass % to 10 mass %. The forming trough 15 may be a zircon-based forming trough or the like. However, in the case of the zircon-based forming trough, when the first molten glass Gm1 having a specific tempered glass composition is caused to flow down therealong, zircornia derived from the forming trough 15 may be mixed in the first molten glass Gm1, and cause a defect in the glass ribbon G and/or the glass sheet Gp. Accordingly, from the viewpoint of preventing the generation of such defect resulting from zirconia, it is more preferred that the forming trough 15 be the alumina-based forming trough.

An internal space of the heat treatment zone 12 has a predetermined temperature gradient toward the lower side. The glass ribbon G in a vertical posture is subjected to heat treatment (annealing) so that its temperature is lowered as the glass ribbon G moves downward through the internal space of the heat treatment zone 12. Through the heat treatment, internal strain of the glass ribbon G is reduced. The temperature gradient of the internal space of the heat treatment zone 12 may be adjusted by, for example, a heating device arranged on an inner surface of the wall portion of the heat treatment zone 12.

The plurality of roller pairs 14 are configured to sandwich both edge portions of the glass ribbon G in a vertical posture in a width direction from both front and rear sides. Of the plurality of roller pairs 14, the roller pair arranged on the top stage is formed of cooling rollers 14a each comprising a cooling mechanism in an inside thereof. In the internal space of the heat treatment zone 12 or the like, the plurality of roller pairs 14 may comprise roller pairs that do not sandwich both the edge portions of the glass ribbon G in the width direction. In other words, an opposing interval of the roller pairs 14 may be set larger than thicknesses of both the edge portions of the glass ribbon G in the width direction so that the glass ribbon G passes between the roller pairs 14.

In this embodiment, both the edge portions of the glass ribbon G obtained by the treatment device 1 in the width direction comprise portions each having a larger thickness than a center portion in the width direction (hereinafter also referred to as “selvage portions”) because of an influence of shrinkage in the course of forming or the like.

The cutting device 2 comprises a scribe line forming device 21 and a splitting device 22, and is configured to cut the glass ribbon G in a vertical posture, which moves downward from the treatment device 1, along the width direction every predetermined length. With this configuration, the glass sheets Gp are successively cut out of the glass ribbon G.

The glass sheet Gp is a glass original sheet (mother glass sheet) from which one or a plurality of product glass sheets are collected. The glass sheet Gp has a thickness of, for example, from 0.2 mm to 10 mm, and has a size of, for example, 700 mm-700 mm to 3,000 mm×3,000 mm. The glass sheet Gp is utilized as, for example, a substrate or a cover glass for a display or a solar cell. The substrate or the cover glass is not limited to a planar shape, and may have a curved shape.

The scribe line forming device 21 is a device for forming a scribe line S on one of front and rear surfaces of the glass ribbon G at a scribe line forming position P1 provided below the treatment device 1. In this embodiment, the scribe line forming device 21 comprises: a wheel cutter 23 for forming the scribe line S on one of the front and rear surfaces of the glass ribbon G along the width direction thereof; and a support member 24 (e.g., a support bar or a support roller) for supporting the other one of the front and rear surfaces of the glass ribbon G at a position corresponding to the wheel cutter 23.

The wheel cutter 23 and the support member 24 are each configured to form the scribe line S on the entire region or a part of the glass ribbon G in the width direction while being lowered so as to follow the glass ribbon G moving downward. In this embodiment, the scribe line S is formed also on both edge portions in the width direction comprising selvage portions each having a relatively large thickness. The scribe line S may be formed by laser irradiation or the like.

The splitting device 22 is a device for splitting the glass ribbon G along the scribe line S at a splitting position P2 provided below the scribe line forming position P1 to provide the glass sheet Gp. In this embodiment, the splitting device 22 comprises: a splitting member 25 to be brought into abutment against a formation region of the scribe line S from a surface side on which the scribe line S is not formed; and a chuck 26 for holding a lower region of the glass ribbon G below the splitting position P2.

The splitting member 25 is formed of a plate-like body (surface plate) having a flat surface to be held in contact with the entire region or a part of the glass ribbon G in the width direction while being lowered so as to follow the glass ribbon G moving downward. A contact surface of the splitting member 25 may be a curved surface that is curved in the width direction.

A plurality of chucks 26 are arranged in each of both the edge portions of the glass ribbon G in the width direction at intervals in the longitudinal direction of the glass ribbon G. The plurality of chucks 26 arranged in each of the edge portions in the width direction are all held by the same arm (not shown). Through an operation of the respective arms, the plurality of chucks 26 perform an operation for curving the glass ribbon G with the splitting member 25 being a fulcrum while being lowered so as to follow the glass ribbon G moving downward. With this configuration, a bending stress is applied to the scribe line S and the vicinity thereof to split the glass ribbon G in the width direction along the scribe line S. As a result, the glass sheet Gp is cut out of the glass ribbon G. The glass sheet Gp having been cut out is delivered from the chuck 26 to another chuck 28 of a conveying device 27, and is then conveyed along the width direction thereof (horizontal direction along the surface of the glass sheet Gp) while maintaining the state of the vertical posture. A conveying direction of the glass sheet Gp by the conveying device 27 is not limited to the width direction, and may be set to an arbitrary direction. The chucks 26 and 28 may each be changed to another holding form based on negative-pressure suction or the like. The cutting method for the glass ribbon G is not limited to the scribe cleaving, and another method, such as laser cleaving or laser melt-cutting, may be used.

The inspection device 3 is a device for inspecting the presence or absence of a defect. The defect includes, for example, a devitrified product derived from the yttrium-containing oxide. For example, the inspection device 3 may be configured to measure thickness unevenness (thickness) in the glass sheet Gp, a stria (cord), and the kind (e.g., bubbles, foreign matter, or the like), position (coordinates), size, and the like of a defect, in addition to the devitrified product derived from the yttrium-containing oxide.

An inspection target of the inspection device 3 is the glass sheet Gp having been cut out of the glass ribbon G. In this embodiment, the inspection device 3 comprises: a light source 31 arranged at a predetermined position on one surface side of the front and rear surfaces of the glass sheet Gp; and a sensor 32 arranged at a predetermined position on the other surface side of the front and rear surfaces of the glass sheet Gp. The light source 31 radiates light toward the glass sheet Gp, and the sensor 32 receives the light having been radiated from the light source 31 and transmitted through the glass sheet Gp. The inspection device 3 detects the presence or absence of a defect based on a change in amount of the light received by the sensor 32.

The light source 31 and the sensor 32 of the inspection device 3 have an inspectable area linearly extending in the Z direction. As an inspection area with the light source 31 and the sensor 32, the front and rear surfaces of the glass sheet Gp are each scanned in its entirety by moving the glass sheet Gp by the conveying device 27. With this configuration, the presence or absence of a defect in the glass sheet Gp is inspected.

In this embodiment, the first molten glass Gm1 (glass ribbon G) is, for example, aluminosilicate glass or alkali-free glass comprising TiO₂. The content of TiO₂ in the first molten glass Gm1 is, for example, 0.001% or more in terms of mass %.

Specifically, it is preferred that the first molten glass Gm1 comprise as a glass composition, in terms of mass %, 50% to 80% of SiO₂, 3% to 25% of Al₂O₃, 0% to 20% of B₂O₃, 0% to 25% of Li₂O+Na₂O+K₂O, 0% to 20% of MgO, 0% to 20% of CaO, 0% to 20% of SrO, 0% to 20% of BaO, 0% to 1% of As₂O₃, 0.0001% to 2% of SnO₂, and 0.001% to 10% of TiO₂, and have a mass ratio SnO₂/(As₂O₃+SnO₂) of from 0.001 to 1. The glass sheet Gp manufactured from the first molten glass Gm1 having such glass composition can reduce the transmittance of ultraviolet light while preventing coloring caused by ultraviolet light, and can be suitably utilized as, for example, a cover glass of a solar cell (glass substrate for space solar power generation) to be used in outer space.

The reasons why the content ranges of the components are limited as described above are described below. In the following description, the expression “%” represents “mass %” unless otherwise specified.

SiO₂ is a component that forms a network. The content thereof is preferably from 50% to 80%, more preferably from 55% to 75%, still more preferably from 55% to 70%, particularly preferably from 55% to 65%. When the content of SiO₂ is large, there are tendencies that viscosity at high temperature is increased, with the result that meltability is reduced, and devitrification stones of cristobalite are liable to precipitate. Meanwhile, when the content of SiO₂ is small, weather resistance is reduced, and vitrification becomes difficult.

Al₂O₃ is a component that increases a strain point and a Young's modulus, and suppresses the precipitation of the devitrification stones of cristobalite. The content thereof is preferably from 3% to 25%, more preferably from 5% to 23%, still more preferably from 7% to 21%, still more preferably from 9% to 18%, particularly preferably from 11% to 17%, most preferably from 13% to 17%. When the content of Al₂O₃ is large, there is a tendency that a liquidus temperature is increased, with the result that it becomes difficult to form glass into a thin sheet. Meanwhile, when the content of Al₂O₃ is small, there are tendencies that the strain point and the Young's modulus are reduced, and the viscosity at high temperature is increased, with the result that the meltability is reduced.

B₂O₃ is a component that acts as a melting accelerate component, and reduces viscosity to improve the meltability. The content thereof is preferably from 5% to 20%, more preferably from 7% to 15%, still more preferably from 8% to 13%, particularly preferably from 8% to 12%, most preferably from 8% to 11%. When the content of B₂O₃ is large, there are tendencies that the strain point and the Young's modulus are reduced, and the weather resistance is reduced. Meanwhile, when the content of B₂O₃ is small, the liquidus temperature is increased, with the result that it becomes difficult to form the glass into a thin sheet. In addition, there is a tendency that the viscosity at high temperature is increased, with the result that the meltability is reduced.

Li₂O, Na₂O, and K₂O are each a component that controls a thermal expansion coefficient, and reduces the viscosity at high temperature. The total content of those components (Li₂O+Na₂O+K₂O) is preferably from 0% to 25%, more preferably from 1% to 20%, still more preferably from 10% to 18%, most preferably from 12% to 18%. When the total content of those components is large, the strain point is reduced, with the result that heat resistance is liable to be reduced. In addition, the thermal expansion coefficient is excessively increased, and its matching property with that of a peripheral member may be impaired. The content of Li₂O is preferably from 0% to 10%, more preferably from 0% to 5%, still more preferably from 0% to 3%, most preferably from 0% to 0.5%. The content of Na₂O is preferably from 0% to 25%, more preferably from 5% to 20%, still more preferably from 10% to 18V, most preferably from 12% to 16%. The content of K₂O is preferably from 0% to 10%, more preferably from 0% to 5%, still more preferably from 0% to 3%, most preferably from 0% to 0.5%.

MgO is a component that improves the meltability without reducing the strain point. The content thereof is preferably from 0% to 20%, more preferably from 0% to 7%, still more preferably from 0% to 5%, particularly preferably from 0% to 3%, most preferably from 0% to 2%. When the content of MgO is large, the liquidus temperature is increased, with the result that it becomes difficult to form the glass into a thin sheet. In addition, the thermal expansion coefficient is increased, and its matching property with that of a peripheral member is impaired. In addition, the density is increased. Meanwhile, when the content of MgO is small, the strain point and the Young's modulus are reduced, and the viscosity at high temperature is increased, with the result that it becomes difficult to melt the glass. The content of MgO is preferably 0.3% or more from the viewpoint of forming and maintaining a Mg-rich layer MR (details are described later) on the surface of the forming trough 15.

CaO is a component that improves the meltability without reducing the strain point. The content thereof is preferably from 0% to 20%, more preferably from 0% to 12%, still more preferably from 3% to 10%, particularly preferably from 3% to 9%. When the content of CaO is large, the liquidus temperature is increased, with the result that it becomes difficult to form the glass. In addition, the thermal expansion coefficient is increased, and its matching property with that of a peripheral member is impaired. In addition, the density is increased. Meanwhile, when the content of CaO is small, the strain point and the Young's modulus are reduced, and the viscosity at high temperature is increased, with the result that it becomes difficult to melt the glass.

SrO is a component that improves the meltability without reducing the strain point. The content thereof is preferably from 0% to 20%, more preferably from 0% to 9%, still more preferably from 0.5% to 8%, particularly preferably from 0.5% to 7%. When the content of SrO is large, the liquidus temperature is increased, with the result that it becomes difficult to form the glass. In addition, the thermal expansion coefficient is increased, and its matching property with that of a peripheral member is impaired. In addition, the density is increased. Meanwhile, when the content of SrO is small, the strain point and the Young's modulus are reduced, and the viscosity at high temperature is increased, with the result that it becomes difficult to melt the glass.

BaO is a component that improves the meltability without reducing the strain point. The content thereof is preferably from 0% to 20%, more preferably from 0% to 8%, still more preferably from 0% to 5%, particularly preferably from 0% to 3%. When the content of BaO is large, the liquidus temperature is increased, with the result that it becomes difficult to form the glass. In addition, the thermal expansion coefficient is increased, and its matching property with that of a peripheral member is impaired. In addition, the density is increased. When the content of BaO is small, the strain point and the Young's modulus are reduced, and the viscosity at high temperature is increased, with the result that it becomes difficult to melt the glass.

Alkaline earth metal oxides, such as MgO, CaO, SrO, and BaO, can each improve the meltability and devitrification resistance of the glass by being mixed to be incorporated therein. However, when the content of those components is large, there is a tendency that the density is increased, and it becomes difficult to achieve weight saving of a glass substrate. Accordingly, the total content of the alkaline earth metal oxides (MgO+CaO+SrO+BaO) is preferably from 0% to 30%, more preferably from 0% t to 20%, still more preferably from 0% to 15%, particularly preferably from 0% to 10%.

The content of Fe₂O₃ is from 0% to 0.05%, preferably from 0.0001% to 0.05%, more preferably from 0.0001% to 0.03%, still more preferably from 0.005% to 0.02%, most preferably from 0.005% to 0.015%. When the content of Fe₂O₃ is large, a visible light transmittance may be excessively reduced. When the content of Fe₂O₃ is small, an ultraviolet light transmittance may be excessively increased.

As₂O₃ is a fining agent, but is a component that promotes solarization (changes in characteristics caused by the influence of light irradiation, such as discoloration caused by ultraviolet light). The content thereof is preferably from 0% to 1%, more preferably from 0, to 0.8%, still more preferably from 0% to 0.5%, particularly preferably from 0% to 0.3%, most preferably from 0% to 0.005%.

SnO₂ is a component that suppresses the solarization. The content thereof is preferably from 0.0001% to 2%, more preferably from 0.001% to 1.5%, still more preferably from 0.01% to 1%, particularly preferably from 0.05% to 0.5%, most preferably from 0.05% to 0.3%. When the content of SnO₂ is large, the devitrification resistance is liable to be reduced. Meanwhile, when the content of SnO₂ is small, it becomes difficult to exhibit the above-mentioned effect. A SnO₂ raw material may be used as a source of SnO₂, but SnO₂ may be incorporated from a trace component in another raw material or the like.

In order to reliably exhibit a suppressing effect on the solarization, it is important to strictly regulate a mass ratio SnO₂/(As₂O₃+SnO₂). A value of the mass ratio SnO₂/(As₂O₃+SnO₂) is preferably from 0.001 to 1, from 0.01 to 1, from 0.1 to 1, from 0.3 to 1, from 0.5 to 1, from 0.7 to 1, or from 0.9 to 1, particularly preferably 1.

TiO₂ is a component that reduces the ultraviolet light transmittance, and has a suppressing effect on the solarization, in addition, when the content of TiO₂ is increased, a devitrified product derived from the yttrium-containing oxide is liable to be generated, and a suppressing effect on the devitrified product exhibited by the present invention becomes remarkable. The content of TiO₂ is preferably from 0.001% to 10%, more preferably from 0.02% to 8%, still more preferably from 0.5% to 6%, particularly preferably from 1% to 5%, most preferably from 2% to 4.5%. When the content of TiO₂ is large, the devitrification resistance is liable to be reduced.

CeO₂ is a component that reduces the ultraviolet light transmittance, and has a suppressing effect on the solarization. The content thereof is preferably from 0.001% to 10%, more preferably from 0.02% to 8%, still more preferably from 0.5% to 6%, particularly preferably from 1% to 5%, most preferably from 2% to 4.5%. When the content of CeO₂ is large, the devitrification resistance is liable to be reduced.

In addition to the above-mentioned components, other components may be introduced as required in terms of total content.

ZnO is a component that increases the Young's modulus and improves the meltability. The content thereof is preferably from 0% to 10%, more preferably from 0% to 5%, still more preferably from 0% to 3%, particularly preferably from 0% to 1%, most preferably from 0% to 0.5%. When the content of ZnO is large, the density and the thermal expansion coefficient are liable to be increased. In addition, there are tendencies that the devitrification resistance and the strain point are reduced.

ZrO₂ is a component that improves the weather resistance. The content thereof is preferably from 0% to 2%, more preferably from 0% to 1%, still more preferably from 0% to 0.5%, particularly preferably from 0% to 0.2%, most preferably from 0% to 0.1%. When the content of ZrO₂ is large, there is a tendency that devitrification stones of zircon precipitate.

Sb₂O₃ is a component that acts as a fining agent. The content thereof is preferably from 0% to 2%, more preferably from 0% to 1.5%, still more preferably from 0% to it, particularly preferably from 0% to 0.5%. When the content of Sb₂O₃ is large, there is a tendency that the density is increased.

Cl is a component that acts as a fining agent. The content thereof is preferably from 0% to 1%, more preferably from 0% to 0.5%. When the content of Cl is large, evaporation from a glass melt is increased, and cords are liable to be generated.

Rare earth oxides, such as Nb₂O₅ and La₂O₃, are each a component that increases the Young's modulus. However, raw materials thereof have high cost in themselves, and the rare earth oxides are each also a component that reduces the devitrification resistance. Accordingly, the content of the rare earth oxides is preferably 3% or less, 27 or less, or 1% or less, particularly preferably 0.5% or less.

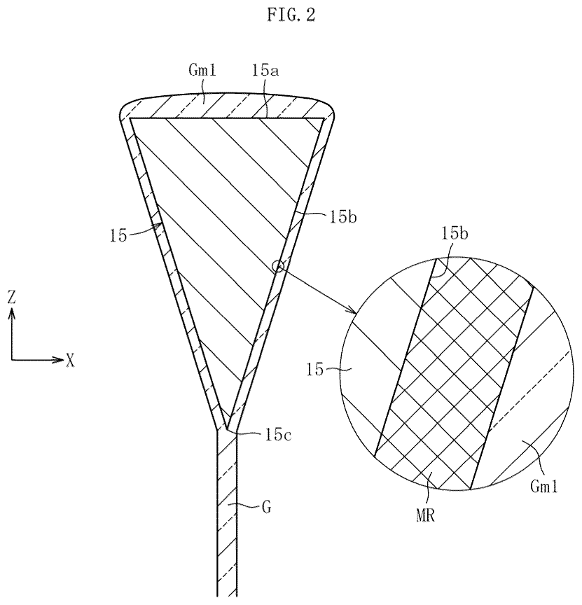

As illustrated in FIG. 2, the forming trough 15 comprises a Mg-rich layer MR comprising magnesium on a surface thereof (e.g., the top 15a and the side surfaces 15b). The Mg-rich layer MR functions as a diffusion suppression layer for suppressing the diffusion of the yttrium-containing oxide included in the forming trough 15.

The Mg-rich layer MR means a layer having a high concentration of magnesium. The content of magnesium in the Mg-rich layer MR is, for example, preferably 1 mass % or more.

The Mg-rich layer MR preferably comprises spinel (MgAl₂O₄) as a main component. When the forming trough 15 is the alumina-based forming trough as in this embodiment, the forming trough 15 comprises alumina, and hence the Mg-rich layer MR comprising spinel is easily formed on the surface of the forming trough 15. When the Mg-rich layer MR comprises spinel as a main component as described above, an upper limit of the content of Mg in the Mg-rich layer MR is 17 mass %. Accordingly, whether or not the Mg-rich layer MR comprises spinel as a main component, the content of Mg in the Mg-rich layer MR is preferably set to 17 mass % or less.

The Mg-rich layer MR has a thickness of preferably 100 μm or less, more preferably from 20 μm to 100 μm, most preferably from 50 μm to 100 μm.

Next, a method of manufacturing a glass article according to this embodiment is described. This manufacturing method is a method of manufacturing the glass sheet Gp serving as a glass article by using the above-mentioned manufacturing apparatus.

As illustrated in FIG. 1, this manufacturing method comprises: a forming step; a heat treatment step; a cooling step; a cutting step; and an inspection step.

The forming step is a step of forming the glass ribbon G in the forming zone 11.

The heat treatment step is a step of subjecting the glass ribbon G having been subjected to the forming step to heat treatment in the heat treatment zone 12.

The cooling step is a step of cooling the glass ribbon G having been subjected to the heat treatment step in the cooling zone 13.

The cutting step is a step of, while conveying the glass ribbon G having been subjected to the cooling step, cutting the glass ribbon G in the width direction by the cutting device 2 to provide the glass sheet Gp.

The inspection step is a step of inspecting the presence or absence of a defect (including a devitrified product derived from the yttrium-containing oxide) in the glass sheet Gp with the inspection device 3 or the like. A cutting step of cutting the selvage portion of the glass sheet Gp may be performed prior to the inspection step.

As illustrated in FIG. 2, in the forming step, the glass ribbon G is continuously formed by causing the first molten glass Gm1 to flow down along the surface of the forming trough 15 comprising an yttrium-containing oxide.

The forming trough 15 has formed on the surface thereof the Mg-rich layer MR serving as the diffusion suppression layer for suppressing the diffusion of the yttrium-containing oxide included in the forming trough 15. That is, in the forming step, the diffusion of the yttrium-containing oxide included in the forming trough 15 into the first molten glass Gm1 can be reliably suppressed with the Mg-rich layer MR. As a result, a reaction between yttrium oxide having diffused from the yttrium-containing oxide included in the forming trough 15 into the first molten glass Gm1 and TiO₂ included in the first molten glass Gm1 is less liable to occur, with the result that the generation of a devitrified product (e.g., Y₂O₃—TiO₂ crystal) derived from the yttrium-containing oxide can be reliably reduced.

When the first molten glass Gm1 comprises 0.3 mass % or more of MgO, the diffusion of a magnesium ion from the Mg-rich layer MR into the first molten glass Gm1 can be suppressed. That is, the reduction, elimination, or alternation of the Mg-rich layer MR due to the diffusion of the magnesium ion can be suppressed. Accordingly, the Mg-rich layer MR can be stably maintained on the surface of the forming trough 15. When the first molten glass Gm1 is substantially free of MgO, the reduction or the like of the Mg-rich layer MR is liable to occur. However, until the Mg-rich layer MR is eliminated, the diffusion of the yttrium-containing oxide included in the forming trough 15 into the first molten glass Gm1 can be suppressed with the Mg-rich layer MR. That is, the Mg-rich layer MR can be applied as the diffusion suppression layer even when the first molten glass Gm1 is substantially free of MgO.

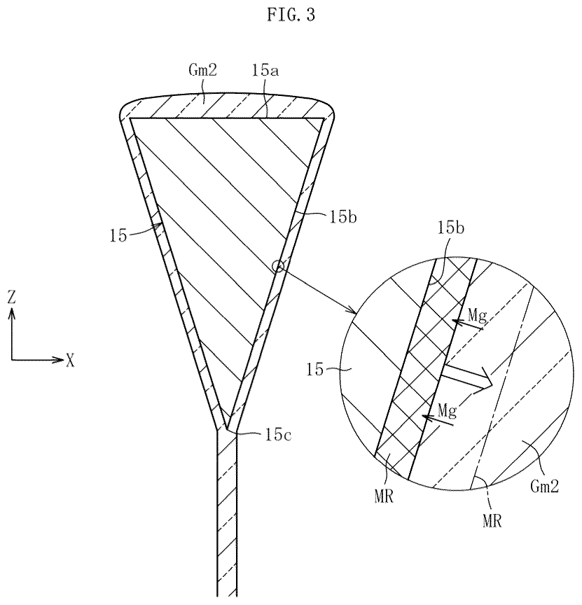

As illustrated in FIG. 3, this manufacturing method further comprises, as a preliminary step to the forming step, a formation step of forming the Mg-rich layer MR.

In the formation step, the Mg-rich layer MR is formed by causing a second molten glass Gm2 comprising MgO to flow down along the surface of the forming trough 15.

Specifically, when the second molten glass Gm2 comprising MgO is caused to flow down along the surface of the forming trough 15, a magnesium ion diffuses from the second molten glass Gm2 into the forming trough 15 to form the Mg-rich layer MR on the surface of the forming trough 15. After that, when a magnesium ion continuously diffuses from the second molten glass Gm2 into the forming trough 15, the thickness of the Mg-rich layer MR is increased up to a predetermined thickness. With this configuration, the Mg-rich layer MR is sufficiently formed on the surface of the forming trough 15. In this course, the yttrium-containing oxide in the surface of the forming trough 15 diffuses into the second molten glass Gm2, and the content of the yttrium-containing oxide in the Mg-rich layer MR is reduced to become, for example, 0 mass % or more and 0.1 mass % or less.

In this embodiment, the forming trough 15 is the alumina-based forming trough, and hence in the above-mentioned formation step, alumina of the forming trough 15 and MgO of the second molten glass Gm2 react with each other to form the Mg-rich layer MR comprising spinel as a main component.

The second molten glass Gm2 is, for example, aluminosilicate glass or alkali-free glass comprising MgO. The second molten glass Gm2 preferably has an identical or similar glass composition comprising MgO to the first molten glass Gm1 to be used for forming the glass ribbon G serving as a product. Alternatively, the second molten glass Gm2 is preferably glass that is substantially free of TiO₂ (e.g., has a content of TiO₂ of less than 0.001%) and comprises MgO.

In the case where the second molten glass Gm2 is substantially free of TiO₂, even when the glass ribbon is formed while the second molten glass Gm2 is caused to flow down along the surface of the forming trough 15 in the formation step, a devitrified product derived from the yttrium-containing oxide is not generated in the glass ribbon to be obtained. Accordingly, a glass substrate can be stably collected from the glass ribbon to be obtained as well.

From the viewpoint of promoting the formation of the Mg-rich layer MR, the content of MgO in the second molten glass Gm2 is preferably 1 mass % or more, more preferably 2 mass % or more. When the first molten glass Gm1 and the second molten glass Gm2 have different glass compositions, the content of MgO in the second molten glass Gm2 is preferably larger than the content of MgO in the first molten glass Gm1.

When the first molten glass Gm1 and the second molten glass Gm2 have different glass compositions, a base changing step of gradually changing molten glass to be supplied to the forming trough 15 from the second molten glass Gm2 to the first molten glass Gm1 is preferably performed after the Mg-rich layer MR is formed. The forming step starts after the completion of the base changing step.

A method of forming the Mg-rich layer MR is not limited thereto. For example, the Mg-rich layer MP may be formed by sputtering film formation.

The manufacturing apparatus for a glass article and the manufacturing method therefor according to the embodiment of the present invention have been described. However, the embodiment of the present invention is not limited thereto and may be variously modified within the range not departing from the spirit of the present invention.

When the Mg-rich layer MR, for example, disappears during the forming step in the above-mentioned embodiment, the formation step may be performed again in order to form the Mg-rich layer MP. That is, the formation step and the forming step may be alternately repeated.

The glass sheet Gp may be a glass to be chemically tempered formed of aluminosilicate glass in the above-mentioned embodiment. In this case, a tempering step of chemically tempering the glass sheet Gp is performed, for example, at the customer's site.

While the case in which the glass article is the glass sheet Gp has been described in the above-mentioned embodiment, the glass article may be, for example, a glass roll in which the glass ribbon G is taken up into a roll shape.

### REFERENCE SIGNS LIST

1 treatment device
2 cutting device
3 inspection device
11 forming zone
12 heat treatment zone
13 cooling zone
14a roller pair (cooling roller)
15 forming trough
21 scribe line forming device
22 splitting device
23 wheel cutter
24 support member
25 splitting member
27 conveying device
G glass ribbon
Gm1 first molten glass
Gp glass sheet
MR Mg-rich layer

1. A method of manufacturing a glass article, comprising a forming step of causing a first molten glass comprising TiO₂ to flow down along a surface of a forming trough comprising an yttrium-containing oxide by a down-draw method to form a glass ribbon,
wherein the forming trough comprises a Mg-rich layer comprising magnesium on the surface of the forming trough.

2. The method of manufacturing a glass article according to claim 1,
wherein the forming trough is an alumina-based forming trough, and
wherein the Mg-rich layer comprises spinel as a main component.

3. The method of manufacturing a glass article according to claim 1, wherein the first molten glass comprises MgO.

4. The method of manufacturing a glass article according to claim 1, further comprising, as a preliminary step to the forming step, a formation step of causing a second molten glass comprising MgO to flow down along the surface of the forming trough to form the Mg-rich layer on the surface of the forming trough.

5. The method of manufacturing a glass article according to claim 1, wherein the first molten glass comprises as a glass composition, in terms of mass %, 50% to 80% of SiO₂, 3% to 25% of Al₂O₃, 0% to 20% of B₂O₃, 0% to 25% of Li₂O+Na₂O+K₂O, 0% to 20% of MgO, 0% to 20% of CaO, 0% to 20% of SrO, 0% to 20% of BaO, 0% to 1% of As₂O₃, 0.0001% to 2% of SnO₂, and 0.001% to 10% of TiO₂, and has a mass ratio SnO₂/(As₂O₃+SnO₂) of from 0.001 to 1.
